(19) United States
(12) Patent Application Publication
(10) Pub. No.: US 2023/0304542 A1
(43) Pub. Date: Sep. 28, 2023

(54) CLUTCH ACTUATOR

(71) Applicant: DENSO CORPORATION, Kariya-city (JP)

(72) Inventors: Motoki ICHIHARA, Kariya-city (JP); Takumi SUGIURA, Kariya-city (JP)

(21) Appl. No.: 18/327,333

(22) Filed: Jun. 1, 2023

Related U.S. Application Data
(63) Continuation of application No. PCT/JP2021/043923, filed on Nov. 30, 2021.

(30) Foreign Application Priority Data
Dec. 3, 2020 (JP) 2020-201318
Apr. 28, 2021 (JP) 2021-076598

(51) Int. Cl. F16D 28/00; F16H 57/08; H02K 7/108; H02K 7/116

(52) U.S. Cl. CPC F16D 28/00; F16H 57/082; H02K 7/108; H02K 7/116; F16D 2127/02

(57) ABSTRACT

A prime mover includes a stator provided in a housing, a rotor provided to be rotatable relative to the stator, and a magnet provided in the rotor, and is operated by energization and capable of outputting a torque from the rotor. A magnet cover is provided to cover at least a part of the magnet. The speed reducer includes a sun gear, a planetary gear, a carrier, a first ring gear, and a second ring gear. The carrier is provided on a radially outer side of the sun gear and on a radially inner side of the first ring gear and the second ring gear to come into contact with the magnet cover or the rotation portion.

### CROSS REFERENCE TO RELATED APPLICATION

The present application is a continuation application of International Patent Application No. PCT/JP2021/043923 filed on Nov. 30, 2021, which designated the U.S. and claims the benefit of priority from Japanese Patent Applications No. 2020-201318 filed on Dec. 3, 2020 and No. 2021-076598 filed on Apr. 28, 2021. The entire disclosures of all of the above applications are incorporated herein by reference.

### TECHNICAL FIELD

The present disclosure relates to a clutch actuator.

### BACKGROUND

Conventionally, a clutch actuator has been used to change a state of a clutch.

### SUMMARY

A clutch actuator according to an aspect of the present disclosure is to be used in a clutch device. The clutch actuator comprises a housing, a prime mover, a magnet cover, a speed reducer, and a rotational translation unit.

### BRIEF DESCRIPTION OF THE DRAWINGS

The above and other objects, features, and advantages of the present disclosure will become more apparent from the following detailed description with reference to the accompanying drawings. In the drawings:

FIG. 1 is a cross-sectional view showing a clutch actuator according to a first embodiment and a clutch device to which the clutch actuator is applied;

FIG. 2 is a cross-sectional view showing a part of the clutch actuator according to the first embodiment and the clutch device;

FIG. 3 is a cross-sectional view showing a part of the clutch actuator according to the first embodiment;

FIG. 4 is a cross-sectional view showing a part of a clutch actuator according to a second embodiment and a clutch device;

FIG. 5 is a cross-sectional view showing a part of a clutch actuator according to a third embodiment;

FIG. 6 is a cross-sectional view showing a part of a clutch actuator according to a fourth embodiment;

FIG. 7 is a cross-sectional view showing a part of a clutch actuator according to a fifth embodiment;

FIG. 8 is a cross-sectional view showing a part of a clutch actuator according to a sixth embodiment; and

FIG. 9 is a cross-sectional view showing a part of a clutch actuator according to a seventh embodiment.

### DETAILED DESCRIPTION

Hereinafter, examples of the present disclosure will be described.

According to an example of the present disclosure, a clutch actuator is capable of changing a state of a clutch that is provided between a first transmission portion and a second transmission portion which are rotatable relative to each other, and whose state is changed between an engaged state in which torque transmission between the first transmission portion and the second transmission portion is permitted and a non-engaged state in which the torque transmission between the first transmission portion and the second transmission portion is blocked.

For example, in a clutch actuator, a speed reducer includes: a sun gear to which a torque from a rotor of a prime mover is inputted; a planetary gear capable of revolving in a circumferential direction of the sun gear while meshing with the sun gear and rotating on its axis; a carrier rotatably supporting the planetary gear and configured to rotate relative to the sun gear; a first ring gear configured to mesh with the planetary gear; and a second ring gear configured to mesh with the planetary gear and output the torque to a rotation portion.

In the clutch actuator, for example, a carrier main body of the carrier is provided at both axial ends of the planetary gear to come into contact with a rotation portion of a rotational translation unit rotating integrally with the second ring gear and the rotor of the prime mover. By bringing the rotation portion and the rotor into contact with the carrier main body, movement of the carrier and the planetary gear in an axial direction is restricted. Accordingly, the speed reducer operates stably.

However, in the clutch actuator, when a magnet provided in the rotor is damaged, the damaged magnet may be scattered to the periphery, which may cause an operation failure of the speed reducer or the like.

In order to restrict movement in the axial direction of the rotor by bringing the rotor into contact with the carrier main body, the rotor is bent in a radial direction and the axial direction with respect to the sun gear, and a shape thereof is complicated.

When the rotor is worn by contact with the carrier main body and sliding, magnetic properties may change. Accordingly, the prime mover may be unstably operated.

A clutch actuator according to an example of to the present disclosure is to be used in a clutch device. The clutch device includes a clutch provided between a first transmission portion and a second transmission portion that are rotatable relative to each other and whose state is changeable between an engaged state in which torque transmission between the first transmission portion and the second transmission portion is permitted and a non-engaged state in which the torque transmission between the first transmission portion and the second transmission portion is blocked. The clutch actuator comprises a housing, a prime mover, a magnet cover, a speed reducer, and a rotational translation unit.

The prime mover includes a stator provided in a housing, a rotor provided to be rotatable relative to the stator, and a magnet provided in the rotor, and is operated by energization and capable of outputting a torque from the rotor. A magnet cover is provided to cover at least a part of the magnet. The speed reducer is capable of outputting a torque of the prime mover at a reduced speed.

The rotational translation unit includes a rotation portion that rotates relative to the housing when the torque output from the speed reducer is input thereto, and a translation portion that moves relative to the housing in an axial direction when the rotation portion rotates relative to the housing and is capable of changing a state of the clutch to an engaged state or a non-engaged state.

The speed reducer includes a sun gear, a planetary gear, a carrier, a first ring gear, and a second ring gear. The torque from the rotor is input to the sun gear. The planetary gear is capable of revolving in a circumferential direction of the sun gear while meshing with the sun gear and rotating on its axis. The carrier rotatably supports the planetary gear and is rotatable relative to the sun gear. The first ring gear is capable of meshing with the planetary gear. The second ring gear is capable of meshing with the planetary gear, has the number of teeth of a tooth portion different from that of the first ring gear, and outputs the torque to the rotation portion.

The carrier is provided on a radially outer side of the sun gear and on a radially inner side of the first ring gear and the second ring gear to come into contact with the magnet cover or the rotation portion. Therefore, the carrier is restricted from moving relative to other members along a radial direction of the sun gear by the sun gear, the first ring gear, and the second ring gear. When the carrier comes into contact with the magnet cover or the rotation portion, the carrier is restricted from moving relative to other members along an axial direction of the sun gear. Therefore, the speed reducer can operate stably.

The magnet cover that covers at least a part of the magnet can reduce a damage to the magnet and scattering to the periphery. Accordingly, it is possible to reduce an operation failure of the prime mover, the speed reducer, and the like. Since the contact between the carrier and the rotor can be reduced by the magnet cover, wear of the rotor and a change in magnetic property can be reduced. Accordingly, a stable operation of the prime mover can be maintained.

Hereinafter, clutch actuators according to multiple embodiments will be described with reference to the drawings. In the multiple embodiments, substantially the same components are denoted by the same reference numerals, and description thereof is omitted.

### First Embodiment

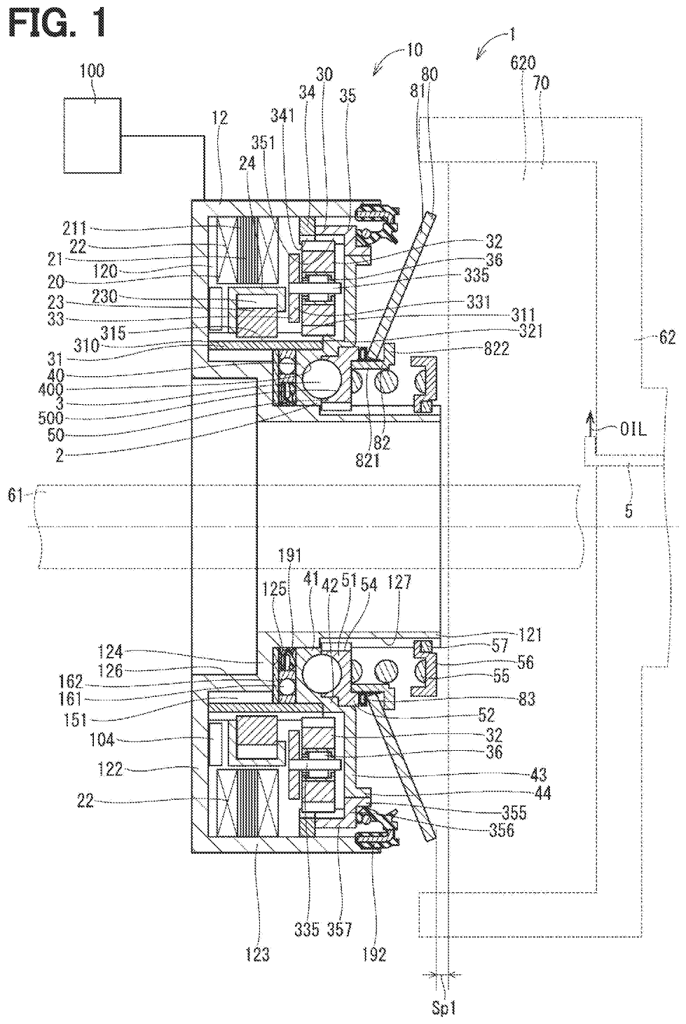

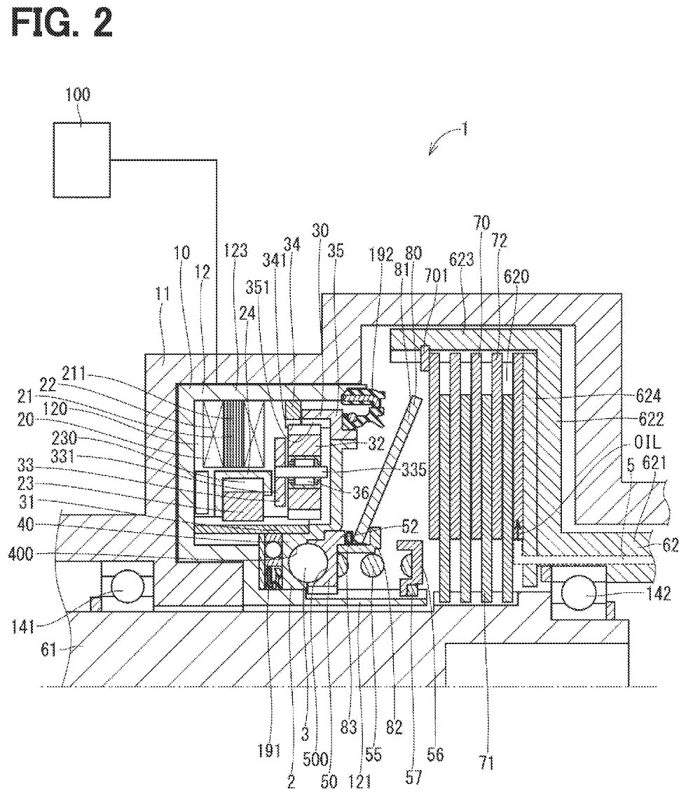

FIGS. 1 and 2 show a clutch device to which a clutch actuator according to a first embodiment is applied. A clutch device 1 is provided, for example, between an internal combustion engine and a transmission of a vehicle, and is used to permit or block torque transmission between the internal combustion engine and the transmission.

The clutch device 1 includes a clutch actuator 10, a clutch 70, an electronic control unit (hereinafter referred to as “ECU”) 100 as a “control unit”, an input shaft 61 as a “first transmission portion”, an output shaft 62 as a “second transmission portion”, and the like.

The clutch actuator 10 includes a housing 12, a motor 20 as a “prime mover”, a magnet cover 24, a speed reducer 30, a ball cam 2 as a “rotational translation unit” or a “rolling body cam”, a state changing unit 80, and the like.

The ECU 100 is a small computer including a CPU as a calculation means, a ROM, a RAM, and the like as a storage means, an I/O as an input and output means, and the like. The ECU 100 executes calculation according to a program stored in the ROM or the like based on information such as signals from various sensors provided in each part of the vehicle, and controls operations of various devices and machines of the vehicle. In this way, the ECU 100 executes a program stored in a non-transitory tangible storage medium. By executing the program, a method corresponding to the program is executed.

The ECU 100 can control an operation of the internal combustion engine and the like based on the information such as the signals from various sensors. The ECU 100 can also control an operation of the motor 20 to be described later.

The input shaft 61 is connected to, for example, a drive shaft of the internal combustion engine (not shown), and is rotatable together with the drive shaft. That is, a torque is input to the input shaft 61 from the drive shaft.

The vehicle equipped with the internal combustion engine is provided with a fixed body 11 (see FIG. 2). The fixed body 11 is formed, for example, in a tubular shape, and is fixed to an engine compartment of the vehicle. A ball bearing 141 is provided between an inner peripheral wall of the fixed body 11 and an outer peripheral wall of the input shaft 61. Accordingly, the input shaft 61 is bearing-supported by the fixed body 11 via the ball bearing 141.

The housing 12 is provided between the inner peripheral wall of the fixed body 11 and the outer peripheral wall of the input shaft 61. The housing 12 includes a housing inner cylinder portion 121, a housing plate portion 122, a housing outer cylinder portion 123, a housing small plate portion 124, a housing step surface 125, a housing small inner cylinder portion 126, housing-side spline groove portions 127, and the like.

The housing inner cylinder portion 121 is formed in a substantially cylindrical shape. The housing small plate portion 124 is formed in an annular plate shape to extend to a radially outer side from an end portion of the housing inner cylinder portion 121. The housing small inner cylinder portion 126 is formed in a substantially cylindrical shape to extend from an outer edge portion of the housing small plate portion 124 to a side opposite to the housing inner cylinder portion 121. The housing plate portion 122 is formed in an annular plate shape to extend to the radially outer side from an end portion of the housing small inner cylinder portion 126 on a side opposite to the housing small plate portion 124. The housing outer cylinder portion 123 is formed in a substantially cylindrical shape to extend from an outer edge portion of the housing plate portion 122 to the same side as the housing small inner cylinder portion 126 and the housing inner cylinder portion 121. Here, the housing inner cylinder portion 121, the housing small plate portion 124, the housing small inner cylinder portion 126, the housing plate portion 122, and the housing outer cylinder portion 123 are integrally formed of, for example, metal.

As described above, the housing 12 is formed in a hollow and flat shape as a whole.

The housing step surface 125 is formed in an annular planar shape on a surface of the housing small plate portion 124 on a side opposite to the housing small inner cylinder portion 126. The housing-side spline groove portion 127 is formed in an outer peripheral wall of the housing inner cylinder portion 121 to extend in an axial direction of the housing inner cylinder portion 121. Multiple housing-side spline groove portions 127 are formed in a circumferential direction of the housing inner cylinder portion 121.

The housing 12 is fixed to the fixed body 11 such that a part of an outer wall is in contact with a part of a wall surface of the fixed body 11 (see FIG. 2). The housing 12 is fixed to the fixed body 11 by bolts (not shown) or the like. Here, the housing 12 is provided coaxially with the fixed body 11 and the input shaft 61. Here, “coaxially” is not limited to a coaxial state in which two axes coincide with each other strictly, and includes a state in which the axes are slightly eccentric or inclined (hereinafter, the same applies). A substantially cylindrical space is formed between an inner peripheral wall of the housing inner cylinder portion 121 and the outer peripheral wall of the input shaft 61.

The housing 12 has an accommodation space 120 as a “space”. The accommodation space 120 is defined by the housing inner cylinder portion 121, the housing small plate portion 124, the housing small inner cylinder portion 126, the housing plate portion 122, and the housing outer cylinder portion 123.

The motor 20 is accommodated in the accommodation space 120. The motor 20 includes a stator 21, a rotor 23, and the like. The stator 21 includes a stator core 211 and a coil 22. The stator core 211 is formed by, for example, a laminated steel plate in a substantially annular shape, and is fixed inside the housing outer cylinder portion 123. The coil 22 is provided on each of multiple salient poles of the stator core 211.

The motor 20 includes a magnet 230 as a “permanent magnet”. The rotor 23 is formed of, for example, iron-based metal in a substantially annular shape. More specifically, the rotor 23 is formed of, for example, pure iron having a relatively high magnetic property.

The magnet 230 is provided on an outer peripheral wall of the rotor 23. Multiple magnets 230 are provided at equal intervals in a circumferential direction of the rotor 23 such that magnetic poles are alternately arranged.

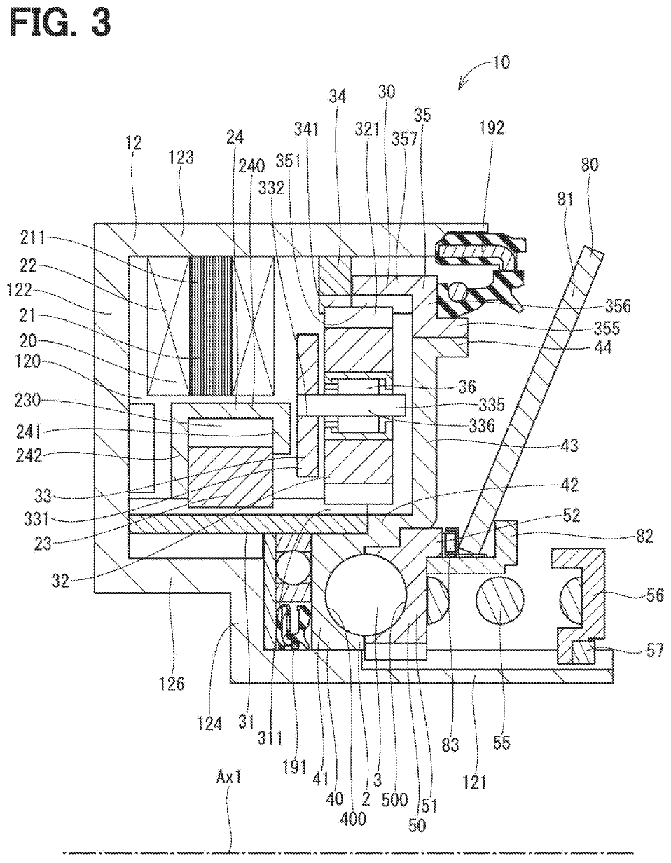

The magnet cover 24 is provided on the rotor 23 to cover at least a part of the magnet 230. More specifically, the magnet cover 24 is made of, for example, non-magnetic metal. As shown in FIG. 3, the magnet cover 24 includes a cover cylinder portion 240, a cover plate portion 241, and a cover plate portion 242.

The cover cylinder portion 240 is formed in a substantially cylindrical shape. The cover plate portion 241 is formed in a substantially annular plate shape to extend from one end portion of the cover cylinder portion 240 to a radially inner side. The cover plate portion 242 is formed in a substantially annular plate shape to extend from the other end portion of the cover cylinder portion 240 to the radially inner side. An inner diameter of the cover plate portion 241 is larger than an inner diameter of the cover plate portion 242. Therefore, a width in a radial direction of the cover plate portion 241 is smaller than a width in the radial direction of the cover plate portion 242.

In a state where the magnet cover 24 is provided on the rotor 23, the cover cylinder portion 240 is located on the radially outer side of the rotor 23 with respect to the magnet 230. The cover plate portion 241 is located on one side of the rotor 23 in the axial direction with respect to the magnet 230. The cover plate portion 242 is located on the other side of the rotor 23 in the axial direction with respect to the magnet 230.

Here, an inner edge portion of the cover plate portion 241 and an inner edge portion of the cover plate portion 242 are located radially inward of the rotor 23 with respect to the magnet 230. In this way, the magnet cover 24 covers portions of the magnet 230 that are exposed from the rotor 23 completely.

The clutch actuator 10 includes a bearing 151. The bearing 151 is provided on an outer peripheral wall of the housing small inner cylinder portion 126. A sun gear 31, which will be described later, is provided on the radially outer side of the bearing 151. The rotor 23 is provided on the radially outer side of the sun gear 31 not to be rotatable relative to the sun gear 31. The bearing 151 is provided in the accommodation space 120 and rotatably supports the sun gear 31, the rotor 23, the magnet 230, and the magnet cover 24.

The ECU 100 can control the operation of the motor 20 by controlling electric power supplied to the coil 22. When the electric power is supplied to the coil 22, a rotating magnetic field is generated in the stator core 211, and the rotor 23 rotates. Accordingly, the torque is output from the rotor 23. As described above, the motor 20 includes the stator 21 and the rotor 23 provided rotatably relative to the stator 21, and can output the torque from the rotor 23 by being supplied with the electric power.

Here, the rotor 23 is provided on the radially inner side of the stator core 211 of the stator 21 to be rotatable relative to the stator 21. The motor 20 is an inner rotor-type brushless DC motor.

In the present embodiment, the clutch actuator 10 includes a rotation angle sensor 104. The rotation angle sensor 104 is provided in the accommodation space 120.

The rotation angle sensor 104 detects a magnetic flux generated from a sensor magnet rotating integrally with the rotor 23, and outputs a signal corresponding to the detected magnetic flux to the ECU 100. Accordingly, the ECU 100 can detect a rotation angle, a rotation speed, and the like of the rotor 23 based on the signal from the rotation angle sensor 104. In addition, the ECU 100 can calculate, based on the rotation angle, the rotation speed, and the like of the rotor 23, a relative rotation angle of a drive cam 40 with respect to the housing 12 and a driven cam 50 to be described later, relative positions of the driven cam 50 and the state changing unit 80 in the axial direction with respect to the housing 12 and the drive cam 40, and the like.

The speed reducer 30 is accommodated in the accommodation space 120. The speed reducer 30 includes the sun gear 31, a planetary gear 32, a carrier 33, a first ring gear 34, a second ring gear 35, and the like.

The sun gear 31 is provided to be coaxially and integrally rotatable with the rotor 23. That is, the rotor 23 and the sun gear 31 are formed separately from different materials, and are coaxially arranged to be integrally rotatable.

More specifically, the sun gear 31 includes a sun gear main body 310, a sun gear tooth portion 311 as a “tooth portion” and “external teeth”, and a gear-side spline groove portion 315. The sun gear main body 310 is formed of, for example, metal in a substantially cylindrical shape. The gear-side spline groove portion 315 is formed to extend in the axial direction on an outer peripheral wall of the sun gear main body 310 on one end portion side. Multiple gear-side spline groove portions 315 are formed in a circumferential direction of the sun gear main body 310. The one end portion side of the sun gear main body 310 is bearing-supported by the bearing 151.

A spline groove portion corresponding to the gear-side spline groove portion 315 is formed in an inner peripheral wall of the rotor 23. The rotor 23 is located on the radially outer side of the sun gear 31, and the spline groove portion is provided to be spline-coupled to the gear-side spline groove portion 315. Accordingly, the rotor 23 is not rotatable relative to the sun gear 31 and is movable relative to the sun gear 31 in the axial direction.

The sun gear tooth portion 311 is formed on an outer peripheral wall of the sun gear 31 on the other end portion side. A torque from the motor 20 is input to the sun gear 31 that rotates integrally with the rotor 23. Here, the sun gear 31 corresponds to an “input unit” of the speed reducer 30. In the present embodiment, the sun gear 31 is formed of, for example, a steel material.

Multiple planetary gears 32 are provided in a circumferential direction of the sun gear 31, and can revolve in the circumferential direction of the sun gear 31 while meshing with the sun gear 31 and rotating on its axis. More specifically, the planetary gears 32 each are formed of, for example, metal in a substantially cylindrical shape, and four planetary gears 32 are provided at equal intervals in the circumferential direction of the sun gear 31 on the radially outer side of the sun gear 31. Each planetary gear 32 includes a planetary gear tooth portion 321 as a “tooth portion” and “external teeth”. The planetary gear tooth portion 321 is formed on an outer peripheral wall of the planetary gear 32 to be capable of meshing with the sun gear tooth portion 311.

The carrier 33 rotatably supports the planetary gear 32 and is rotatable relative to the sun gear 31.

More specifically, the carrier 33 includes a carrier main body 331 and a pin 335. The carrier main body 331 is formed of, for example, metal in a substantially annular plate shape. The carrier main body 331 is located between the rotor 23, the magnet cover 24, and the coil 22 and the planetary gear 32 in the axial direction. In the carrier main body 331, a carrier hole portion 332 penetrating the carrier main body 331 in a plate thickness direction is formed.

The pin 335 includes a pin main body 336. The pin main body 336 is formed of, for example, metal in a substantially columnar shape. The pin 335 is provided on the carrier main body 331 such that an end portion in the axial direction of the pin main body 336 is fitted into the carrier hole portion 332. Here, an end surface of the end portion of the pin main body 336 that is fitted into the carrier hole portion 332 is located on the same plane as an end surface of the carrier main body 331. The pins 335 and the carrier hole portions 332 correspond to the number of planetary gears 32, and four pins 335 and four carrier hole portions 332 are provided at equal intervals in the circumferential direction of the carrier main body 331.

The speed reducer 30 includes a planetary gear bearing 36. The planetary gear bearing 36 is provided between an outer peripheral wall of the pin 335 and an inner peripheral wall of the planetary gear 32. Accordingly, the planetary gear 32 is rotatably supported by the pin 335 via the planetary gear bearing 36. That is, the pin 335 is provided at a rotation center of the planetary gear 32 and rotatably supports the planetary gear 32. The planetary gear 32 is movable relative to the pin 335 in the axial direction within a predetermined range via the planetary gear bearing 36. In other words, the planetary gear bearing 36 restricts a range of relative movement between the planetary gear 32 and the pin 335 in the axial direction to a predetermined range.

The first ring gear 34 includes a first ring gear tooth portion 341 which is a tooth portion that is capable of meshing with the planetary gear 32, and is fixed to the housing 12. More specifically, the first ring gear 34 is formed of, for example, metal in a substantially annular shape. The first ring gear 34 is fixed to the housing 12 on a side opposite to the housing plate portion 122 with respect to the coil 22 such that an outer edge portion of the first ring gear 34 fits into an inner peripheral wall of the housing outer cylinder portion 123. Therefore, the first ring gear 34 is not rotatable relative to the housing 12.

Here, the first ring gear 34 is provided coaxially with the housing 12, the rotor 23, and the sun gear 31. The first ring gear tooth portion 341 as a “tooth portion” and “internal teeth” is formed in an inner edge portion of the first ring gear 34 to be able to mesh with one end portion side in the axial direction of the planetary gear tooth portion 321 of the planetary gear 32.

The second ring gear 35 includes a second ring gear tooth portion 351 that is a tooth portion capable of meshing with the planetary gear 32 and has a tooth number different from that of the first ring gear tooth portion 341, and is provided to be integrally rotatable with the drive cam 40 to be described later. More specifically, the second ring gear 35 is formed of, for example, metal in a substantially annular shape. The second ring gear 35 includes a gear inner cylinder portion 355, a gear plate portion 356, and a gear outer cylinder portion 357. The gear inner cylinder portion 355 is formed in a substantially cylindrical shape. The gear plate portion 356 is formed in an annular plate shape to extend to the radially outer side from one end of the gear inner cylinder portion 355. The gear outer cylinder portion 357 is formed in a substantially cylindrical shape to extend from an outer edge portion of the gear plate portion 356 to a side opposite to the gear inner cylinder portion 355.

Here, the second ring gear 35 is provided coaxially with the housing 12, the rotor 23, and the sun gear 31. The second ring gear tooth portion 351 as a “tooth portion” and “internal teeth” is formed on an inner peripheral wall of the gear outer cylinder portion 357 to be capable of meshing with the other end portion side in the axial direction of the planetary gear tooth portion 321 of the planetary gear 32. In the present embodiment, the number of teeth of the second ring gear tooth portion 351 is larger than the number of teeth of the first ring gear tooth portion 341. More specifically, the number of teeth of the second ring gear tooth portion 351 is larger than the number of teeth of the first ring gear tooth portion 341 by a number obtained by multiplying 4, which is the number of planetary gears 32, by an integer.

Since the planetary gear 32 is required to normally mesh with the first ring gear 34 and the second ring gear 35 having two different specifications at the same portion without interference, the planetary gear 32 is designed such that one or both of the first ring gear 34 and the second ring gear 35 are displaced to keep a center distance between each gear pair constant.

With the above configuration, when the rotor 23 of the motor 20 rotates, the sun gear 31 rotates, and the planetary gear tooth portion 321 of the planetary gear 32 revolves in the circumferential direction of the sun gear 31 while meshing with the sun gear tooth portion 311, the first ring gear tooth portion 341, and the second ring gear tooth portion 351 and rotating on its axis. Here, since the number of teeth of the second ring gear tooth portion 351 is larger than the number of teeth of the first ring gear tooth portion 341, the second ring gear 35 rotates relative to the first ring gear 34. Therefore, a minute differential rotation between the first ring gear 34 and the second ring gear 35 corresponding to a difference in the number of teeth between the first ring gear tooth portion 341 and the second ring gear tooth portion 351 is output as a rotation of the second ring gear 35. Accordingly, a torque from the motor 20 is decelerated by the speed reducer 30 and output from the second ring gear 35. In this way, the speed reducer 30 is capable of outputting the torque from the motor 20 at a reduced speed. In the present embodiment, the speed reducer 30 constitutes a 3 k-type strange planetary gear speed reducer.

The second ring gear 35 is formed separately from the drive cam 40 to be described later, and is provided to be integrally rotatable with the drive cam 40. The second ring gear 35 outputs the torque from the motor 20 at a reduced speed to the drive cam 40. Here, the second ring gear 35 corresponds to an “output unit” of the speed reducer 30.

The ball cam 2 includes the drive cam 40 as a “rotation portion”, the driven cam 50 as a “translation portion”, and a ball 3 as a “rolling body”.

The drive cam 40 includes a drive cam main body 41, a drive cam inner cylinder portion 42, a drive cam plate portion 43, a drive cam outer cylinder portion 44, a drive cam groove 400, and the like. The drive cam main body 41 is formed in a substantially annular plate shape. The drive cam inner cylinder portion 42 is formed in a substantially cylindrical shape to extend in the axial direction from an outer edge portion of the drive cam main body 41. The drive cam plate portion 43 is formed in a substantially annular plate shape to extend to the radially outer side from an end portion of the drive cam inner cylinder portion 42 on a side opposite to the drive cam main body 41. The drive cam outer cylinder portion 44 is formed in a substantially cylindrical shape to extend from an outer edge portion of the drive cam plate portion 43 to a side opposite to the drive cam inner cylinder portion 42. Here, the drive cam main body 41, the drive cam inner cylinder portion 42, the drive cam plate portion 43, and the drive cam outer cylinder portion 44 are integrally formed of, for example, metal.

The drive cam groove 400 is formed to be recessed from one end surface, which is a surface of the drive cam main body 41 on a drive cam inner cylinder portion 42 side, toward the other end surface. The drive cam groove 400 is formed such that a depth from one end surface changes in a circumferential direction of the drive cam main body 41. For example, three drive cam grooves 400 are formed at equal intervals in a circumferential direction of the drive cam main body 41.

The drive cam 40 is provided between the housing inner cylinder portion 121 and the housing outer cylinder portion 123 such that the drive cam main body 41 is located between the outer peripheral wall of the housing inner cylinder portion 121 and an inner peripheral wall of the sun gear 31, and the drive cam plate portion 43 is located on a side opposite to the carrier main body 331 with respect to the planetary gear 32. The drive cam 40 is rotatable relative to the housing 12.

The second ring gear 35 is provided integrally with the drive cam 40 such that an inner peripheral wall of the gear inner cylinder portion 355 is fitted to an outer peripheral wall of the drive cam outer cylinder portion 44. The second ring gear 35 is not rotatable relative to the drive cam 40. That is, the second ring gear 35 is provided to be integrally rotatable with the drive cam 40 as a “rotation portion”. Therefore, when the torque from the motor 20 is decelerated by the speed reducer 30 and output from the second ring gear 35, the drive cam 40 rotates relative to the housing 12. That is, when the torque output from the speed reducer 30 is input to the drive cam 40, the drive cam 40 rotates relative to the housing 12.

The driven cam 50 includes a driven cam main body 51, a driven cam cylinder portion 52, cam-side spline groove portions 54, driven cam grooves 500, and the like. The driven cam main body 51 is formed in a substantially annular plate shape. The driven cam cylinder portion 52 is formed in a substantially cylindrical shape to extend in the axial direction from an outer edge portion of the driven cam main body 51. Here, the driven cam main body 51 and the driven cam cylinder portion 52 are integrally formed of, for example, metal.

The cam-side spline groove portions 54 are formed to extend in the axial direction on an inner peripheral wall of the driven cam main body 51. Multiple cam-side spline groove portions 54 are formed in a circumferential direction of the driven cam main body 51.

The driven cam 50 is provided such that the driven cam main body 51 is located on a side opposite to the housing step surface 125 with respect to the drive cam main body 41 and the radially inner side of the drive cam inner cylinder portion 42 and the drive cam plate portion 43, and the cam-side spline groove portions 54 are spline-coupled to the housing-side spline groove portions 127. Accordingly, the driven cam 50 is not rotatable relative to the housing 12 and is movable relative to the housing 12 in the axial direction.

The driven cam groove 500 is formed to be recessed from one end surface, which is a surface of the driven cam main body 51 on a drive cam main body 41 side, toward the other end surface. The driven cam groove 500 is formed such that a depth from one end surface changes in the circumferential direction of the driven cam main body 51. For example, three driven cam grooves 500 are formed at equal intervals in the circumferential direction of the driven cam main body 51.

The drive cam groove 400 and the driven cam groove 500 are formed to have the same shape when viewed from a surface side of the drive cam main body 41 on a driven cam main body 51 side or from a surface side of the driven cam main body 51 on the drive cam main body 41 side.

The ball 3 is formed in a spherical shape of, for example, metal. Balls 3 are provided to be rollable between the three drive cam grooves 400 and the three driven cam grooves 500. That is, three balls 3 are provided in total.

In this way, the drive cam 40, the driven cam 50, and the balls 3 constitute the ball cam 2 as a “rolling body cam”. When the drive cam 40 rotates relative to the housing 12 and the driven cam 50, the balls 3 roll along the respective groove bottoms in the drive cam grooves 400 and the driven cam grooves 500.

As shown in FIG. 1, the balls 3 are provided on the radially inner side of the first ring gear 34 and the second ring gear 35. More specifically, most of the balls 3 are provided within a range in the axial direction of the first ring gear 34 and the second ring gear 35.

As described above, the drive cam grooves 400 and the driven cam grooves 500 are formed such that the depth changes in the circumferential direction of the drive cam 40 or the driven cam 50. Therefore, when the drive cam 40 rotates relative to the housing 12 and the driven cam 50 by the torque output from the speed reducer 30, the balls 3 roll in the drive cam grooves 400 and the driven cam grooves 500, and the driven cam 50 moves relative to the drive cam 40 and the housing 12 in the axial direction, that is, strokes.

In this way, the driven cam 50 has multiple driven cam grooves 500 formed on one end surface to sandwich the ball 3 between the driven cam 50 and the drive cam groove 400, and constitutes the ball cam 2 together with the drive cam 40 and the ball 3. When the drive cam 40 rotates relative to the housing 12, the driven cam 50 moves relative to the drive cam 40 and the housing 12 in the axial direction. Here, since the cam-side spline groove portions 54 are spline-coupled to the housing-side spline groove portions 127, the driven cam 50 does not rotate relative to the housing 12. The drive cam 40 rotates relative to the housing 12, but does not move relative to the housing 12 in the axial direction.

In the present embodiment, the clutch actuator 10 includes a return spring 55 as an “urging member”, a return spring retainer 56, and a C ring 57. The return spring 55 is, for example, a coil spring, and is provided on the radially outer side of an end portion of the housing inner cylinder portion 121 on a side opposite to the housing small plate portion 124 on a side of the driven cam main body 51 opposite to the drive cam main body 41. One end of the return spring 55 is in contact with a surface of the driven cam main body 51 on a side opposite to the drive cam main body 41.

The return spring retainer 56 is formed of, for example, metal in a substantially annular shape, and is in contact with the other end of the return spring 55 on the radially outer side of the housing inner cylinder portion 121. The C ring 57 is fixed to the outer peripheral wall of the housing inner cylinder portion 121 to lock a surface of an inner edge portion of the return spring retainer 56 on a side opposite to the driven cam main body 51.

The return spring 55 has a force extending in the axial direction. Therefore, the driven cam 50 is urged toward the drive cam main body 41 by the return spring 55 in a state where the ball 3 is sandwiched between the driven cam 50 and the drive cam 40.

The output shaft 62 includes a shaft portion 621, a plate portion 622, a cylinder portion 623, and a friction plate 624 (see FIG. 2). The shaft portion 621 is formed in a substantially cylindrical shape. The plate portion 622 is formed integrally with the shaft portion 621 to extend in an annular plate shape from one end of the shaft portion 621 to the radially outer side. The cylinder portion 623 is formed integrally with the plate portion 622 to extend in a substantially cylindrical shape from an outer edge portion of the plate portion 622 to a side opposite to the shaft portion 621. The friction plate 624 is formed in a substantially annular plate shape, and is provided on an end surface of the plate portion 622 on a cylinder portion 623 side. Here, the friction plate 624 is not rotatable relative to the plate portion 622. A clutch space 620 is formed in an inside of the cylinder portion 623.

An end portion of the input shaft 61 passes through an inside of the housing inner cylinder portion 121 and is located on a side opposite to the drive cam 40 with respect to the driven cam 50. The output shaft 62 is provided coaxially with the input shaft 61 on the side opposite to the drive cam 40 with respect to the driven cam 50. A ball bearing 142 is provided between an inner peripheral wall of the shaft portion 621 and an outer peripheral wall of the end portion of the input shaft 61. Accordingly, the output shaft 62 is bearing-supported by the input shaft 61 via the ball bearing 142. The input shaft 61 and the output shaft 62 are rotatable relative to the housing 12.

The clutch 70 is provided between the input shaft 61 and the output shaft 62 in the clutch space 620. The clutch 70 includes inner friction plates 71, outer friction plates 72, and a locking portion 701. Multiple inner friction plates 71 each are formed in a substantially annular plate shape, and are aligned in the axial direction between the input shaft 61 and the cylinder portion 623 of the output shaft 62. Each inner friction plate 71 is provided such that an inner edge portion is spline-coupled to the outer peripheral wall of the input shaft 61. Therefore, the inner friction plate 71 is not rotatable relative to the input shaft 61 and is movable relative to the input shaft 61 in the axial direction.

Multiple outer friction plates 72 each are formed in a substantially annular plate shape, and are aligned in the axial direction between the input shaft 61 and the cylinder portion 623 of the output shaft 62. Here, the inner friction plates 71 and the outer friction plates 72 are alternately arranged in the axial direction of the input shaft 61. Each outer friction plate 72 is provided such that an outer edge portion thereof is spline-coupled to an inner peripheral wall of the cylinder portion 623 of the output shaft 62. Therefore, the outer friction plate 72 is not rotatable relative to the output shaft 62 and is movable relative to the output shaft 62 in the axial direction. The outer friction plate 72 located closest to the friction plate 624 among the multiple outer friction plates 72 is contactable with the friction plate 624.

The locking portion 701 is formed in a substantially annular shape, and is provided such that an outer edge portion thereof is fitted to the inner peripheral wall of the cylinder portion 623 of the output shaft 62. The locking portion 701 is capable of locking an outer edge portion of the outer friction plate 72 located closest to the driven cam 50 among the multiple outer friction plates 72. Therefore, the multiple outer friction plates 72 and the multiple inner friction plates 71 are prevented from coming off from the inside of the cylinder portion 623. A distance between the locking portion 701 and the friction plate 624 is larger than a total plate thickness of the multiple outer friction plates 72 and the multiple inner friction plates 71.

In an engaged state in which the multiple inner friction plates 71 and the multiple outer friction plates 72 are in contact with each other, that is, engaged with each other, a frictional force is generated between the inner friction plates 71 and the outer friction plates 72, and relative rotation between the inner friction plates 71 and the outer friction plates 72 is restricted according to a magnitude of the frictional force. On the other hand, in a non-engaged state in which the multiple inner friction plates 71 and the multiple outer friction plates 72 are separated from each other, that is, are not engaged with each other, no frictional force is generated between the inner friction plates 71 and the outer friction plates 72, and the relative rotation between the inner friction plates 71 and the outer friction plates 72 is not restricted.

When the clutch 70 is in the engaged state, a torque input to the input shaft 61 is transmitted to the output shaft 62 via the clutch 70. On the other hand, when the clutch 70 is in the non-engaged state, the torque input to the input shaft 61 is not transmitted to the output shaft 62.

In this way, the clutch 70 transmits the torque between the input shaft 61 and the output shaft 62. The clutch 70 permits torque transmission between the input shaft 61 and the output shaft 62 during the engaged state in which the clutch 70 is engaged, and blocks the torque transmission between the input shaft 61 and the output shaft 62 during the non-engaged state in which the clutch 70 is not engaged.

In the present embodiment, the clutch device 1 is a so-called normally open (normally open type) clutch device that is normally in the non-engaged state.

The state changing unit 80 includes a disk spring 81 as an “elastic deformation portion”, a disk spring retainer 82, and a thrust bearing 83. The disk spring retainer 82 includes a retainer cylinder portion 821 and a retainer flange portion 822. The retainer cylinder portion 821 is formed in a substantially cylindrical shape. The retainer flange portion 822 is formed in an annular plate shape to extend from one end of the retainer cylinder portion 821 to the radially outer side. The retainer cylinder portion 821 and the retainer flange portion 822 are integrally formed of, for example, metal. The disk spring retainer 82 is fixed to the driven cam 50 such that an outer peripheral wall of the other end of the retainer cylinder portion 821 is fitted to an inner peripheral wall of the driven cam cylinder portion 52.

The disk spring 81 is provided such that an inner edge portion thereof is located between the driven cam cylinder portion 52 and the retainer flange portion 822 on a radially outer side of the retainer cylinder portion 821. The thrust bearing 83 is provided between the driven cam cylinder portion 52 and the disk spring 81.

The disk spring retainer 82 is fixed to the driven cam 50 such that the retainer flange portion 822 is capable of locking one end in the axial direction, that is, an inner edge portion of the disk spring 81. Therefore, the disk spring 81 and the thrust bearing 83 are prevented from coming off from the disk spring retainer 82 by the retainer flange portion 822. The disk spring 81 is elastically deformable in the axial direction.

As shown in FIGS. 1 and 2, when the ball 3 is located at a position (origin) corresponding to a deepest portion which is a portion farthest from one end surface of the drive cam groove 400 in the axial direction of the drive cam main body 41, that is, in the depth direction, and at a position (origin) corresponding to a deepest portion which is a portion farthest from one end surface of the driven cam groove 500 in the axial direction of the driven cam main body 51, that is, in the depth direction, a distance between the drive cam 40 and the driven cam 50 is relatively small, and a gap Sp1 is formed between the clutch 70 and the other end of the disk spring 81 in the axial direction, that is, the outer edge portion (see FIG. 1). Therefore, the clutch 70 is in the non-engaged state, and the torque transmission between the input shaft 61 and the output shaft 62 is blocked.

Here, when electric power is supplied to the coil 22 of the motor 20 under control of the ECU 100 during a normal operation for changing a state of the clutch 70, the motor 20 rotates, a torque is output from the speed reducer 30, and the drive cam 40 rotates relative to the housing 12. Accordingly, the ball 3 rolls from the position corresponding to the deepest portion to one side in the circumferential direction of the drive cam groove 400 and the driven cam groove 500. Accordingly, the driven cam 50 moves relative to the housing 12 in the axial direction, that is, moves toward the clutch 70 while compressing the return spring 55. Accordingly, the disk spring 81 moves toward the clutch 70.

When the disk spring 81 moves toward the clutch 70 due to the movement of the driven cam 50 in the axial direction, the gap Sp1 decreases, and the other end of the disk spring 81 in the axial direction comes into contact with the outer friction plate 72 of the clutch 70. When the driven cam 50 further moves in the axial direction after the disk spring 81 comes into contact with the clutch 70, the disk spring 81 presses the outer friction plate 72 toward the friction plate 624 while being elastically deformed in the axial direction. Accordingly, the multiple inner friction plates 71 and the multiple outer friction plates 72 are engaged with each other, and the clutch 70 is in the engaged state. Therefore, the torque transmission between the input shaft 61 and the output shaft 62 is permitted.

At this time, the disk spring 81 rotates relative to the driven cam 50 and the disk spring retainer 82 while being bearing-supported by the thrust bearing 83. In this way, the thrust bearing 83 bearing-supports the disk spring 81 while receiving a load in a thrust direction from the disk spring 81.

When a clutch transmission torque reaches a clutch required torque capacity, the ECU 100 stops the rotation of the motor 20. Accordingly, the clutch 70 is in an engagement maintaining state where the clutch transmission torque is maintained at the clutch required torque capacity. In this way, the disk spring 81 of the state changing unit 80 is capable of receiving a force in the axial direction from the driven cam 50, and changing the state of the clutch 70 to the engaged state or the non-engaged state according to a relative position of the driven cam 50 in the axial direction with respect to the housing 12 and the drive cam 40.

An end portion of the shaft portion 621 on a side opposite to the plate portion 622 is connected to an input shaft of a transmission (not shown), and the output shaft 62 is rotatable together with the input shaft. That is, the torque output from the output shaft 62 is input to the input shaft of the transmission. The torque input to the transmission is changed in speed by the transmission, and is output to drive wheels of the vehicle as a drive torque. Accordingly, the vehicle travels.

In the present embodiment, the clutch device 1 includes an oil supply portion 5 (see FIGS. 1 and 2). The oil supply portion 5 is formed in a passage shape in the output shaft 62 such that one end of the oil supply portion 5 is exposed to the clutch space 620. The other end of the oil supply portion 5 is connected to an oil supply source (not shown). Accordingly, oil is supplied from the one end of the oil supply portion 5 to the clutch 70 in the clutch space 620.

The ECU 100 controls an amount of oil to be supplied from the oil supply portion 5 to the clutch 70. The oil supplied to the clutch 70 is capable of lubricating and cooling the clutch 70. In this way, in the present embodiment, the clutch 70 is a wet clutch and can be cooled by oil.

In the present embodiment, the ball cam 2 as a “rotational translation unit” forms the accommodation space 120 between the drive cam 40 as a “rotation portion” and the housing 12, and between the second ring gear 35 and the housing 12. Here, the accommodation space 120 is formed inside the housing 12 on a side opposite to the clutch 70 with respect to the drive cam 40 and the second ring gear 35. The motor 20 and the speed reducer 30 are provided in the accommodation space 120. The clutch 70 is provided in the clutch space 620, which is a space on a side opposite to the accommodation space 120 with respect to the drive cam 40.

In the present embodiment, the clutch actuator 10 includes a thrust bearing 161 and a thrust bearing washer 162. The thrust bearing washer 162 is formed of, for example, metal in a substantially annular plate shape, and is provided such that one surface thereof is in contact with the housing step surface 125. The thrust bearing 161 is provided between the other surface of the thrust bearing washer 162 and a surface of the drive cam main body 41 on a side opposite to the driven cam 50. The thrust bearing 161 bearing-supports the drive cam 40 while receiving a load in the thrust direction from the drive cam 40. In the present embodiment, the load in the thrust direction that acts on the drive cam 40 from the clutch 70 via the driven cam 50 acts on the housing step surface 125 via the thrust bearing 161 and the thrust bearing washer 162. Therefore, the drive cam 40 can be stably bearing-supported by the housing step surface 125.

In the present embodiment, the clutch actuator 10 includes an inner sealing member 191 and an outer sealing member 192 as “seal members”. The inner sealing member 191 and the outer sealing member 192 are oil seals each formed in an annular shape using an elastic material such as rubber and a metal ring.

An inner diameter and an outer diameter of the inner sealing member 191 are smaller than an inner diameter and an outer diameter of the outer sealing member 192.

The inner sealing member 191 is located between the housing inner cylinder portion 121 and the thrust bearing 161 in the radial direction, and is located between the thrust bearing washer 162 and the drive cam main body 41 in the axial direction. The inner sealing member 191 is fixed to the housing inner cylinder portion 121 and is rotatable relative to the drive cam 40.

The outer sealing member 192 is provided between the gear inner cylinder portion 355 of the second ring gear 35 and an end portion of the housing outer cylinder portion 123 on the clutch 70 side. The outer sealing member 192 is fixed to the housing outer cylinder portion 123 and is rotatable relative to the second ring gear 35.

Here, the outer sealing member 192 is provided to be located on the radially outer side of the inner sealing member 191 when viewed in an axial direction of the inner sealing member 191 (see FIGS. 1 and 2).

A surface of the drive cam main body 41 on a thrust bearing washer 162 side is slidable on a seal lip portion of the inner sealing member 191. That is, the inner sealing member 191 is provided to come into contact with the drive cam 40 as a “rotation portion”. The inner sealing member 191 seals the drive cam main body 41 and the thrust bearing washer 162 in an airtight or liquid-tight manner.

An outer peripheral wall of the gear inner cylinder portion 355 of the second ring gear 35 is slidable on a seal lip portion, which is an inner edge portion of the outer sealing member 192. That is, the outer sealing member 192 is provided to come into contact with the second ring gear 35 that rotates integrally with the drive cam 40 on the radially outer side of the drive cam 40 as a “rotation portion”. The outer sealing member 192 seals the outer peripheral wall of the gear inner cylinder portion 355 and the inner peripheral wall of the housing outer cylinder portion 123 in an airtight or liquid-tight manner.

By the inner sealing member 191 and the outer sealing member 192 provided as described above, the accommodation space 120 in which the motor 20 and the speed reducer 30 are accommodated can be maintained in an airtight or liquid-tight manner, and the accommodation space 120 and the clutch space 620 provided with the clutch 70 can be maintained in an airtight or liquid-tight manner. Accordingly, for example, even if a foreign matter such as abrasion powder is generated in the clutch 70, the foreign matter can be reduced from entering the accommodation space 120 from the clutch space 620. Therefore, an operation failure of the motor 20 or the speed reducer 30 caused by the foreign matter can be reduced.

Hereinafter, the configuration of each portion according to the present embodiment will be described in more detail.

The carrier 33 is provided on the radially outer side of the sun gear 31 and on radially inner sides of the first ring gear 34 and the second ring gear 35 to come into contact with the magnet cover 24 or the drive cam 40 as a “rotation portion”.

More specifically, the carrier 33, particularly a portion of the carrier 33 other than an end portion fitted to the carrier hole portion 332 of the pin 335 is located on the radially outer side of the sun gear 31 and on the radially inner side of the first ring gear 34 and the second ring gear 35.

The planetary gear 32 is provided between the sun gear 31, the first ring gear 34, and the second ring gear 35. Therefore, the planetary gear 32 is restricted from moving relative to other members along a radial direction of the sun gear 31 by the sun gear 31, the first ring gear 34, and the second ring gear 35. Accordingly, the carrier 33 that rotatably supports the planetary gear 32 is also restricted from moving relative to other members along the radial direction of the sun gear 31.

A surface of the carrier main body 331 on a magnet cover 24 side and an end surface of an end portion of the pin main body 336 fitted to the carrier hole portion 332 may come into contact with a surface of the cover plate portion 241 on a side opposite to the cover plate portion 242. Here, the carrier main body 331, the pin main body 336, and the magnet cover 24 may be in surface contact with each other. When the carrier main body 331 and the pin main body 336 are in contact with the magnet cover 24, the carrier 33 is restricted from moving relative to other members along the axial direction of the sun gear 31.

An end surface of the pin main body 336 on a side opposite to the carrier main body 331 may come into contact with a surface of the drive cam plate portion 43 on a planetary gear 32 side. Here, the pin main body 336 and the drive cam plate portion 43 may be in surface contact with each other. When the pin main body 336 and the drive cam plate portion 43 are in contact with each other, the carrier 33 is restricted from moving relative to other members along the axial direction of the sun gear 31.

The end surface of the pin main body 336 on the side opposite to the carrier main body 331 is located on a drive cam plate portion 43 side with respect to end surfaces of the planetary gear 32 and the planetary gear bearing 36 on the drive cam plate portion 43 side. Therefore, although the end surface of the pin main body 336 on the side opposite to the carrier main body 331 may be in contact with the drive cam plate portion 43, the end surfaces of the planetary gear 32 and the planetary gear bearing 36 on the drive cam plate portion 43 side do not come into contact with the drive cam plate portion 43 and the gear plate portion 356.

As described above, in the present embodiment, the carrier 33 is provided on the radially outer side of the sun gear 31 and on radially inner sides of the first ring gear 34 and the second ring gear 35 to come into contact with the magnet cover 24 or the drive cam 40 as a “rotation portion”.

Therefore, the carrier 33 is restricted from moving relative to other members along the radial direction of the sun gear 31 by the sun gear 31, the first ring gear 34, and the second ring gear 35. When the carrier 33 comes into contact with the magnet cover 24 or the drive cam 40, the carrier 33 is restricted from moving relative to other members along the axial direction of the sun gear 31. Therefore, the speed reducer 30 can operate stably.

The magnet cover 24 that covers at least a part of the magnet 230 can reduce a damage to the magnet 230 and scattering to the periphery. Accordingly, it is possible to reduce an operation failure of the motor 20, the speed reducer 30, and the like. Since the contact between the carrier 33 and the rotor 23 can be reduced by the magnet cover 24, wear of the rotor 23 and a change in magnetic property can be reduced. Accordingly, a stable operation of the motor 20 can be maintained.

As described above, in the present embodiment, the carrier 33 is provided on the radially outer side of the sun gear 31 and on the radially inner side of the first ring gear 34 and the second ring gear 35, so that the carrier 33 is restricted from moving along the radial direction of the sun gear 31, and the carrier 33 is provided to come into contact with the magnet cover 24 or the drive cam 40 as a “rotation portion”, so that the carrier 33 is restricted from moving along the axial direction of the sun gear 31.

In the present embodiment, the carrier 33 includes the pin 335 that is provided at the rotation center of the planetary gear 32 such that an end portion of the pin 335 is to come into contact with the magnet cover 24 or the drive cam 40 as a “rotation portion”.

Therefore, when an end portion of the pin 335 comes into contact with the magnet cover 24 or the drive cam 40, the carrier 33 is restricted from moving relative to other members along the axial direction of the sun gear 31.

Thus, in the present embodiment, the carrier 33 includes the pin 335 that is provided at the rotation center of the planetary gear 32 such that the end portion of the pin 335 is to come into contact with the magnet cover 24 or a rotation portion, and the end portion of the pin 335 comes into contact with the magnet cover 24 or the drive cam 40 as the “rotation portion”, so that the carrier 33 is restricted from moving along the axial direction of the sun gear 31.

### Second Embodiment

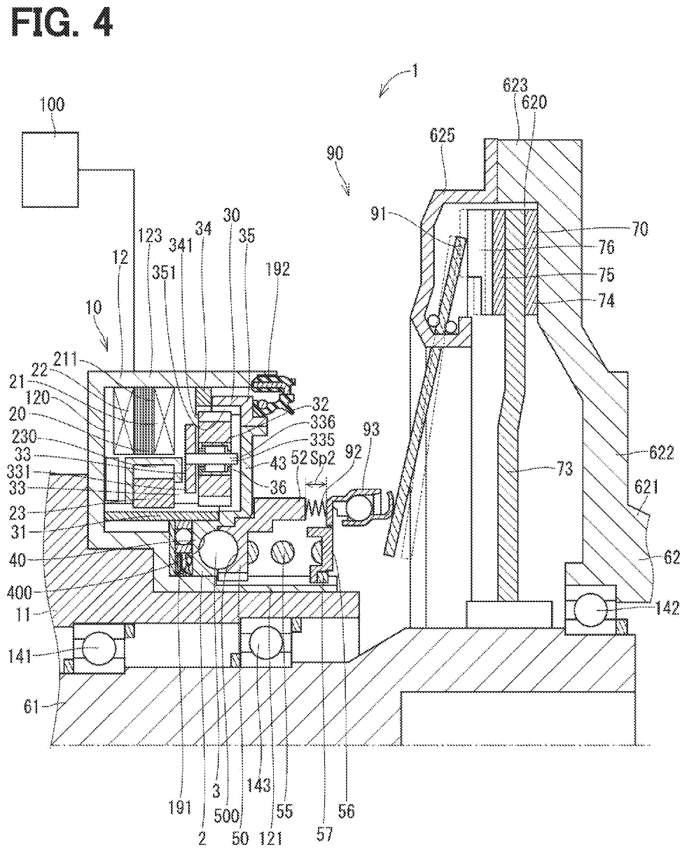

FIG. 4 shows a part of a clutch device to which a clutch actuator according to a second embodiment is applied. The second embodiment is different from the first embodiment in configurations of a clutch and a state changing unit, and the like.

In the present embodiment, ball bearings 141 and 143 are provided between the inner peripheral wall of the fixed body 11 and the outer peripheral wall of the input shaft 61. Accordingly, the input shaft 61 is bearing-supported by the fixed body 11 via the ball bearings 141 and 143.

The housing 12 is fixed to the fixed body 11 such that a part of an outer wall is in contact with a wall surface of the fixed body 11. For example, the housing 12 is fixed to the fixed body 11 such that a surface of the housing small plate portion 124 on a side opposite to the ball 3, the inner peripheral wall of the housing inner cylinder portion 121, and an inner peripheral wall of the housing small inner cylinder portion 126 is in contact with an outer wall of the fixed body 11. The housing 12 is fixed to the fixed body 11 by bolts (not shown) or the like. Here, the housing 12 is provided coaxially with the fixed body 11 and the input shaft 61.

An arrangement of the motor 20, the speed reducer 30, the ball cam 2, and the like with respect to the housing 12 is the same as that in the first embodiment.

In the present embodiment, the output shaft 62 includes the shaft portion 621, the plate portion 622, the cylinder portion 623, and a cover 625. The shaft portion 621 is formed in a substantially cylindrical shape. The plate portion 622 is formed integrally with the shaft portion 621 to extend in an annular plate shape from one end of the shaft portion 621 to the radially outer side. The cylinder portion 623 is formed integrally with the plate portion 622 to extend in a substantially cylindrical shape from an outer edge portion of the plate portion 622 to a side opposite to the shaft portion 621. The output shaft 62 is bearing-supported by the input shaft 61 via the ball bearing 142. The clutch space 620 is formed in the inside of the cylinder portion 623.

The clutch 70 is provided between the input shaft 61 and the output shaft 62 in the clutch space 620. The clutch 70 includes a support portion 73, a friction plate 74, a friction plate 75, and a pressure plate 76. The support portion 73 is formed in a substantially annular plate shape to extend from an outer peripheral wall of an end portion of the input shaft 61 to the radially outer side on a driven cam 50 side with respect to the plate portion 622 of the output shaft 62.

The friction plate 74 is formed in a substantially annular plate shape, and is provided on a plate portion 622 side of the output shaft 62 on an outer edge portion of the support portion 73. The friction plate 74 is fixed to the support portion 73. The friction plate 74 is contactable with the plate portion 622 by deforming the outer edge portion of the support portion 73 toward the plate portion 622.

The friction plate 75 is formed in a substantially annular plate shape, and is provided on a side opposite to the plate portion 622 of the output shaft 62 on the outer edge portion of the support portion 73. The friction plate 75 is fixed to the support portion 73.

The pressure plate 76 is formed in a substantially annular plate shape, and is provided on the driven cam 50 side with respect to the friction plate 75.

In an engaged state in which the friction plate 74 and the plate portion 622 are in contact with each other, that is, engaged with each other, a frictional force is generated between the friction plate 74 and the plate portion 622, and relative rotation between the friction plate 74 and the plate portion 622 is restricted according to a magnitude of the frictional force. On the other hand, in a non-engaged state in which the friction plate 74 and the plate portion 622 are separated from each other, that is, are not engaged with each other, no frictional force is generated between the friction plate 74 and the plate portion 622, and the relative rotation between the friction plate 74 and the plate portion 622 is not restricted.

When the clutch 70 is in the engaged state, a torque input to the input shaft 61 is transmitted to the output shaft 62 via the clutch 70. On the other hand, when the clutch 70 is in the non-engaged state, the torque input to the input shaft 61 is not transmitted to the output shaft 62.

The cover 625 is formed in a substantially annular shape, and is provided on the cylinder portion 623 of the output shaft 62 to cover the pressure plate 76 from a side opposite to the friction plate 75.

In the present embodiment, the clutch actuator 10 of the clutch device 1 includes a state changing unit 90 instead of the state changing unit 80 shown in the first embodiment. The state changing unit 90 includes a diaphragm spring 91 as an “elastic deformation portion”, a return spring 92, a release bearing 93, and the like.

The diaphragm spring 91 is formed in a substantially annular disk spring shape, and is provided on the cover 625 such that one end in an axial direction, that is, an outer edge portion of the diaphragm spring 91 is in contact with the pressure plate 76. Here, the diaphragm spring 91 is formed such that the outer edge portion of the diaphragm spring 91 is located on a clutch 70 side with respect to an inner edge portion of the diaphragm spring 91, and a portion between the inner edge portion and the outer edge portion is supported by the cover 625. The diaphragm spring 91 is elastically deformable in the axial direction. Accordingly, the diaphragm spring 91 urges the pressure plate 76 toward the friction plate 75 by one end in the axial direction, that is, an outer edge portion. Accordingly, the pressure plate 76 is pressed against the friction plate 75, and the friction plate 74 is pressed against the plate portion 622. That is, the clutch 70 is normally in the engaged state.

In the present embodiment, the clutch device 1 is a so-called normally closed (normally closed type) clutch device that is normally in the engaged state.

The return spring 92 is, for example, a coil spring, and is provided such that one end thereof is in contact with an end surface of the driven cam cylinder portion 52 on the clutch 70 side.

The release bearing 93 is provided between the other end of the return spring 92 and the inner edge portion of the diaphragm spring 91. The return spring 92 urges the release bearing 93 toward the diaphragm spring 91. The release bearing 93 bearing-supports the diaphragm spring 91 while receiving a load in a thrust direction from the diaphragm spring 91. An urging force of the return spring 92 is smaller than an urging force of the diaphragm spring 91.

As shown in FIG. 4, when the ball 3 is located at a position (origin) corresponding to a deepest portion of the drive cam groove 400 and the driven cam groove 500, a distance between the drive cam 40 and the driven cam 50 is relatively small, and a gap Sp2 is formed between the release bearing 93 and the driven cam step surface 53 of the driven cam 50. Therefore, the friction plate 74 is pressed against the plate portion 622 by the urging force of the diaphragm spring 91, the clutch 70 is in the engaged state, and torque transmission between the input shaft 61 and the output shaft 62 is permitted.

Here, when the electric power is supplied to the coil 22 of the motor 20 under the control of the ECU 100, the motor 20 rotates, the torque is output from the speed reducer 30, and the drive cam 40 rotates relative to the housing 12. Accordingly, the ball 3 rolls from the position corresponding to the deepest portion to one side in the circumferential direction of the drive cam groove 400 and the driven cam groove 500. Accordingly, the driven cam 50 moves relative to the housing 12 and the drive cam 40 in the axial direction, that is, moves toward the clutch 70. Accordingly, the gap Sp2 between the release bearing 93 and an end surface of the driven cam cylinder portion 52 is reduced, and the return spring 92 is compressed in the axial direction between the driven cam 50 and the release bearing 93.

When the driven cam 50 further moves toward the clutch 70, the return spring 92 is maximally compressed, and the release bearing 93 is pressed toward the clutch 70 by the driven cam 50. Accordingly, the release bearing 93 moves toward the clutch 70 against a reaction force from the diaphragm spring 91 while pressing the inner edge portion of the diaphragm spring 91.

When the release bearing 93 moves toward the clutch 70 while pressing the inner edge portion of the diaphragm spring 91, the inner edge portion of the diaphragm spring 91 moves toward the clutch 70, and the outer edge portion of the diaphragm spring 91 moves toward a side opposite to the clutch 70. Accordingly, the friction plate 74 is separated from the plate portion 622, and a state of the clutch 70 is changed from the engaged state to the non-engaged state. As a result, the torque transmission between the input shaft 61 and the output shaft 62 is blocked.

When a clutch transmission torque is 0, the ECU 100 stops the rotation of the motor 20. Accordingly, the state of the clutch 70 is maintained in the non-engaged state. Thus, the diaphragm spring 91 of the state changing unit 90 is capable of receiving a force in the axial direction from the driven cam 50, and changing the state of the clutch 70 to the engaged state or the non-engaged state according to a relative position of the driven cam 50 in the axial direction with respect to the drive cam 40.

In the present embodiment, the clutch device 1 does not include the oil supply portion 5 described in the first embodiment. That is, in the present embodiment, the clutch 70 is a dry clutch.

Thus, the present disclosure is also applicable to a normally closed clutch device including a dry clutch.

### Third Embodiment

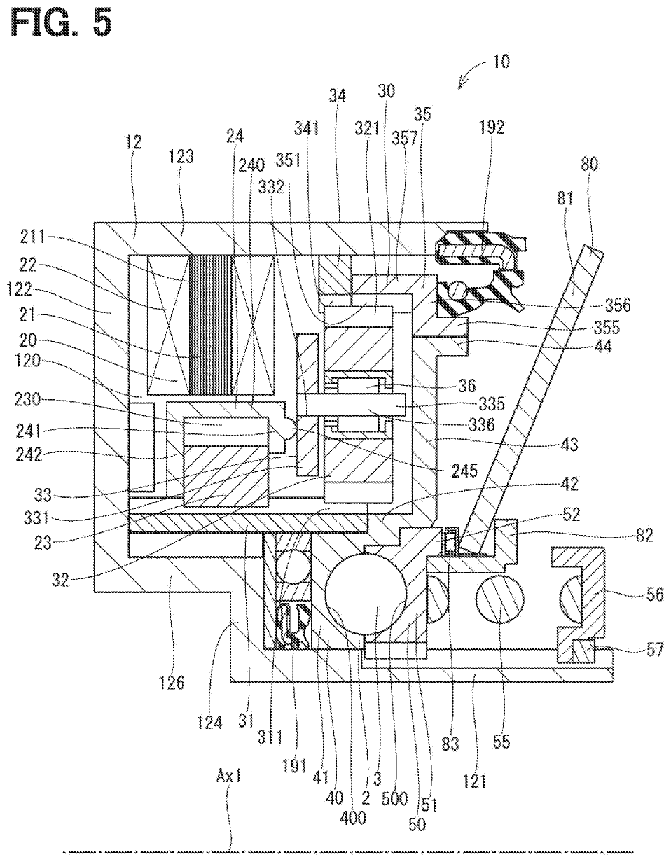

FIG. 5 shows a part of a clutch actuator according to a third embodiment. The third embodiment is different from the first embodiment in a configuration of the magnet cover 24 and the like.

In the present embodiment, the magnet cover 24 further includes a cover protruding portion 245. The cover protruding portion 245 is formed in a hemispherical shape to protrude toward the carrier main body 331 from a surface of the cover plate portion 241 on a side opposite to the cover plate portion 242. An outer wall of the cover protruding portion 245 is formed in a spherical shape.

The outer wall of the cover protruding portion 245 may come into contact with the surface of the carrier main body 331 on the magnet cover 24 side. Here, the cover protruding portion 245 and the carrier main body 331 are in point contact with each other. For example, four cover protruding portions 245 are formed at equal intervals in a circumferential direction of the cover plate portion 241.

The outer wall of the cover protruding portion 245 that may come into contact with the carrier main body 331 of the carrier 33 is formed such that a shape of the outer wall in a cross section along a plane including an axis Ax1 of the magnet cover 24 is a curved shape that protrudes toward the carrier 33 (see FIG. 5).

As described above, in the present embodiment, the magnet cover 24 has the cover protruding portion 245 that may come into contact with the carrier 33.

Therefore, a contact area between the carrier 33 and the magnet cover 24 can be reduced as compared with the first embodiment in which the cover protruding portion 245 is not provided. Accordingly, a sliding resistance between the carrier 33 and the magnet cover 24 can be reduced, and a sliding loss of the carrier 33 can be reduced.

Thus, in the present embodiment, the magnet cover 24 has the cover protruding portion 245 that may come into contact with the carrier 33, and when the cover protruding portion 245 comes into contact with the carrier 33, the carrier 33 can be restricted from moving along the axial direction of the sun gear 31.

In the present embodiment, the outer wall of the cover protruding portion 245 that may come into contact with the carrier 33 is formed such that the shape of the outer wall in the cross section along the plane including an axis Ax1 of the magnet cover 24 is the curved shape that protrudes toward the carrier 33.

Therefore, the carrier 33 and the cover protruding portion 245 can be brought into point contact, and the contact area between the carrier 33 and the magnet cover 24 can be further reduced. Accordingly, the sliding resistance between the carrier 33 and the magnet cover 24 can be further reduced, and the sliding loss of the carrier 33 can be further reduced.

### Fourth Embodiment

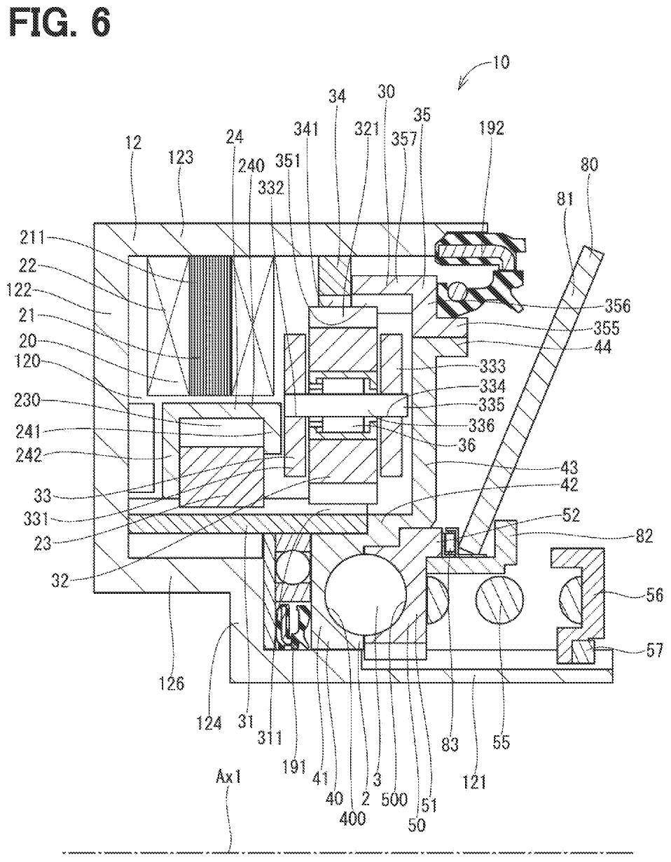

FIG. 6 is a cross-sectional view showing a part of a clutch actuator according to a fourth embodiment. The fourth embodiment is different from the first embodiment in a configuration of the carrier 33 and the like.

In the present embodiment, the carrier 33 further includes a carrier main body 333. The carrier main body 333 is formed of, for example, metal in a substantially annular plate shape. The carrier main body 333 is located between the drive cam plate portion 43 and the planetary gear 32 in the axial direction. In the carrier main body 333, a carrier hole portion 334 penetrating the carrier main body 333 in a plate thickness direction is formed.

An end portion of the pin main body 336 on the side opposite to the carrier main body 331 is fitted into the carrier hole portion 334. The end surface of the pin main body 336 on the side opposite to the carrier main body 331 is located on the drive cam plate portion 43 side with respect to an end surface of the carrier main body 333 on the drive cam plate portion 43 side. Therefore, although the end surface of the pin main body 336 on the side opposite to the carrier main body 331 may be in contact with the drive cam plate portion 43, the end surface of the carrier main body 333 on the drive cam plate portion 43 side does not come into contact with the drive cam plate portion 43 and the gear plate portion 356.

A width of the carrier main body 333 in the radial direction is smaller than a diameter of a root circle of the planetary gear 32. Therefore, an outer edge portion of the carrier main body 333 does not come into contact with the second ring gear tooth portion 351, and an inner edge portion of the carrier main body 333 does not come into contact with the drive cam inner cylinder portion 42.

### Fifth Embodiment

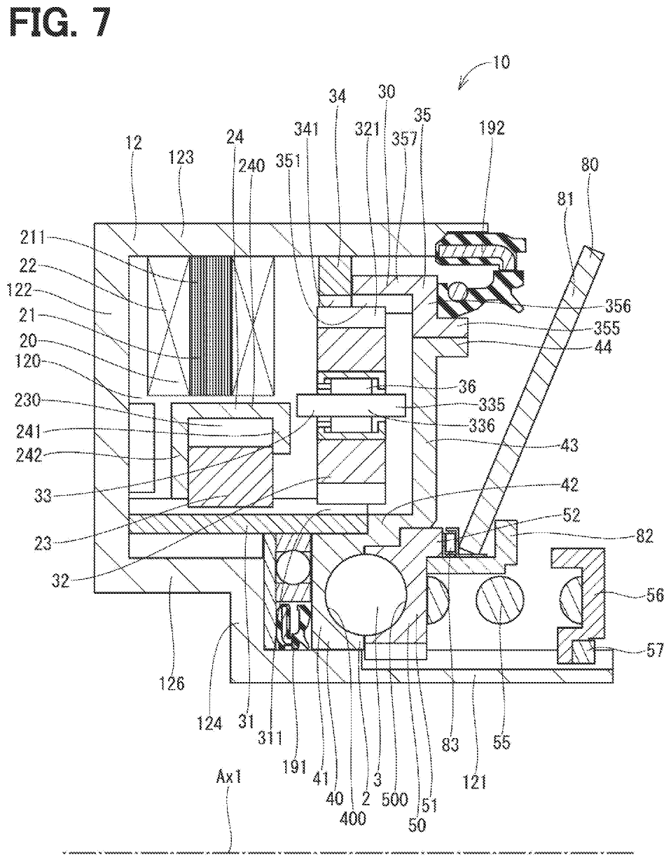

FIG. 7 shows a part of a clutch actuator according to a fifth embodiment. The fifth embodiment is different from the first embodiment in a configuration of the carrier 33 and the like.

In the present embodiment, the carrier 33 does not include the carrier main body 331 described in the first embodiment. An end surface of the pin main body 336 on the magnet cover 24 side may come into contact with surfaces of the cover cylinder portion 240 and the cover plate portion 241 on the planetary gear 32 side. Here, the pin main body 336 and the magnet cover 24 may be in surface contact with each other. When the pin main body 336 and the magnet cover 24 come into contact with each other, the carrier 33 is restricted from moving relative to other members along the axial direction of the sun gear 31.

An end surface of the pin main body 336 on the drive cam plate portion 43 side may come into contact with the surface of the drive cam plate portion 43 on the planetary gear 32 side. Here, the pin main body 336 and the drive cam plate portion 43 may be in surface contact with each other. When the pin main body 336 and the drive cam plate portion 43 are in contact with each other, the carrier 33 is restricted from moving relative to other members along the axial direction of the sun gear 31.

The end surface of the pin main body 336 on the magnet cover 24 side is located on the magnet cover 24 side with respect to end surfaces of the planetary gear 32 and the planetary gear bearing 36 on the magnet cover 24 side. Therefore, although the end surface of the pin main body 336 on the magnet cover 24 side may come into contact with the magnet cover 24, the end surfaces of the planetary gear 32 and the planetary gear bearing 36 on the magnet cover 24 side do not come into contact with the magnet cover 24.

The end surface of the pin main body 336 on the drive cam plate portion 43 side is located on the drive cam plate portion 43 side with respect to the end surfaces of the planetary gear 32 and the planetary gear bearing 36 on the drive cam plate portion 43 side. Therefore, although the end surface of the pin main body 336 on the drive cam plate portion 43 side may be in contact with the drive cam plate portion 43, the end surfaces of the planetary gear 32 and the planetary gear bearing 36 on the drive cam plate portion 43 side do not come into contact with the drive cam plate portion 43 and the gear plate portion 356.

In the present embodiment, the carrier 33 does not include the carrier main body 331 described in the first embodiment. Therefore, the configuration of the carrier 33 can be simplified, and the clutch actuator 10 can be reduced in weight.

### Sixth Embodiment

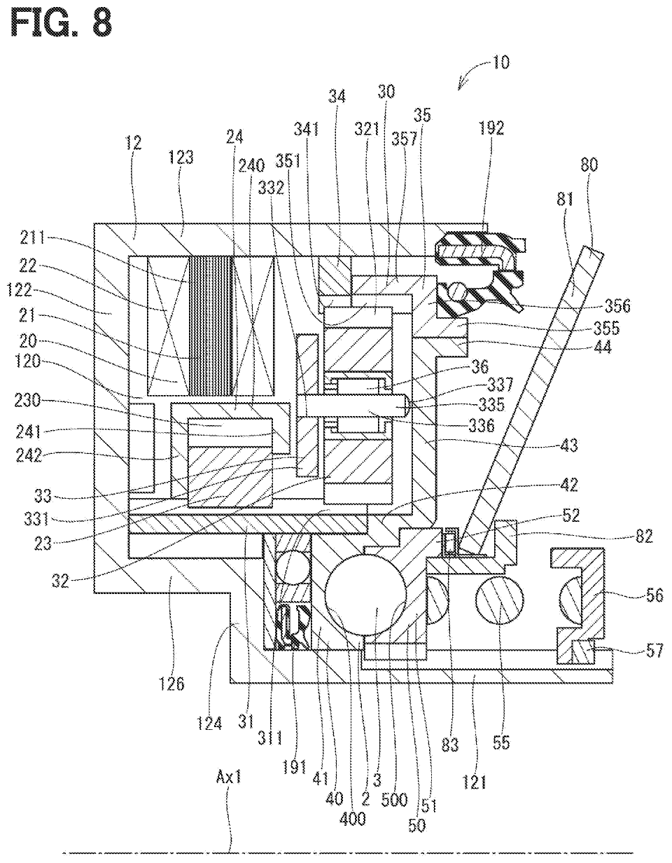

FIG. 8 shows a part of a clutch actuator according to a sixth embodiment. The sixth embodiment is different from the first embodiment in a configuration of the carrier 33 and the like.

In the present embodiment, the pin 335 further includes a pin protruding portion 337. The pin protruding portion 337 is formed to protrude toward the drive cam plate portion 43 from the end surface of the pin main body 336 on the drive cam plate portion 43 side. An outer wall of the pin protruding portion 337 is formed into a spherical shape. Thus, an end portion of the pin 335 on the drive cam plate portion 43 side is formed in a spherical shape.

The outer wall of the pin protruding portion 337 may come into contact with the surface of the drive cam plate portion 43 on the planetary gear 32 side. Here, the pin protruding portion 337 and the drive cam plate portion 43 are in point contact with each other.

The outer wall of the pin protruding portion 337 that may come into contact with the drive cam plate portion 43 is formed such that a shape of the outer wall in a cross section along a plane including an axis of the pin main body 336 is a curved shape that protrudes toward the drive cam plate portion 43 (see FIG. 8).

As described above, in the present embodiment, the end portion of the pin 335 is formed in a spherical shape.

Therefore, a contact area between the pin 335 and the drive cam plate portion 43 can be reduced as compared with the first embodiment in which the pin 335 does not have the pin protruding portion 337. Accordingly, a sliding resistance between the carrier 33 and the drive cam 40 can be reduced, and the sliding loss of the carrier 33 can be reduced.

### Seventh Embodiment

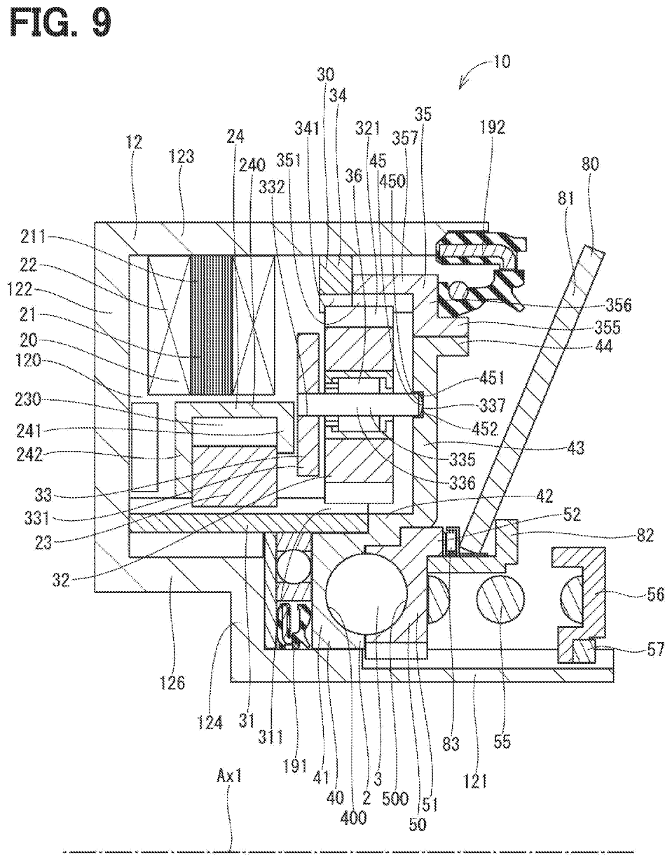

FIG. 9 shows a part of a clutch actuator according to a seventh embodiment. The seventh embodiment is different from the first embodiment in a configuration of the drive cam 40 and the like.

In the present embodiment, the drive cam 40 as a “rotation portion” further includes a pin sliding groove portion 45. The pin sliding groove portion 45 is formed in an annular shape to be recessed from the surface of the drive cam plate portion 43 on the planetary gear 32 side toward a side opposite to the planetary gear 32.

The pin sliding groove portion 45 is formed along a revolution orbit circle of the pin 335 with respect to the sun gear 31. A groove bottom surface 450, which is a bottom surface of the pin sliding groove portion 45, is formed in an annular planar shape. A groove side surface 451, which is a side surface of the pin sliding groove portion 45 on the radially outer side, is formed in a cylindrical surface shape. A groove side surface 452, which is a side surface of the pin sliding groove portion 45 on the radially inner side, is formed in a cylindrical surface shape. A distance between the groove side surface 451 and the groove side surface 452 in a radial direction of the drive cam plate portion 43 is slightly larger than a diameter of the pin main body 336.

An end portion of the pin 335 on the side opposite to the carrier main body 331, that is, an end portion of the pin main body 336 on the side opposite to the carrier main body 331 and the pin protruding portion 337 are located in the pin sliding groove portion 45, and come into contact with and slide in the pin sliding groove portion 45 when the speed reducer 30 is operated.

More specifically, the outer wall of the pin protruding portion 337 may come into point-contact with and slide on the groove bottom surface 450. An outer peripheral wall of the end portion of the pin main body 336 on the side opposite to the carrier main body 331 may come into point-contact with and slide on the groove side surface 451 or the groove side surface 452.

When the outer peripheral wall of the pin main body 336 comes into contact with the groove side surface 451 or the groove side surface 452 of the pin sliding groove portion 45, the carrier 33 is restricted from moving relative to other members along the radial direction of the sun gear 31.

As described above, in the present embodiment, the drive cam 40 as a “rotation portion” has an annular pin sliding groove portion 45 on which the end portion of the pin 335 is slidable.

Therefore, when the end portion of the pin 335 comes into contact with the pin sliding groove portion 45, the carrier 33 is restricted from moving relative to other members along the axial direction or radial direction of the sun gear 31. Therefore, the speed reducer 30 can operate stably.

### Other Embodiments

In other embodiments, a “magnet cover” may not cover all the portions of a “magnet” as long as the “magnet cover” is provided to cover at least a portion of the “magnet”.

In other embodiments, a “carrier” may be provided to come into contact with only one of the “magnet cover” and a “rotation portion”.

In the third embodiment described above, an example in which the “magnet cover” includes four hemispherical “cover protruding portions” has been described. In contrast, in other embodiments, the “cover protruding portion” may be formed in a shape other than the hemispherical shape, such as a columnar shape. The number of “cover protruding portions” may be any number. Here, it is desirable that three or more “cover protruding portions” are formed at equal intervals in a circumferential direction of the “magnet cover”.

In other embodiments, one “cover protruding portion” may be formed to protrude from the “magnet cover” toward the “carrier” in a substantially annular shape, and may be formed to come into contact with the “carrier”. Here, an outer wall of the “cover protruding portion” that is to come into contact with the “carrier” may be formed such that a shape of the outer wall in a cross section along a plane including an axis of the “magnet cover” is a curved shape that protrudes toward the “carrier”. In this case, the “cover protruding portion” and the “carrier” can be brought into line contact with each other, and a contact area between the “cover protruding portion” and the “carrier” can be reduced as compared with the case where the “cover protruding portion” and the “carrier” are in surface contact with each other. Accordingly, a sliding resistance between the “carrier” and the “magnet cover” can be reduced, and a sliding loss of the “carrier” can be reduced.

In the seventh embodiment described above, an example in which the “rotation portion” which is one of the “magnet cover” and the “rotation portion” has an annular “pin sliding groove portion” on which an end portion of a “pin” is slidable has been described. Alternatively, in other embodiments, only the “magnet cover” or both the “magnet cover” and the “rotation portion” may have the “pin sliding groove portion”. When the “magnet cover” and the “rotation portion” both have the “pin sliding groove portion”, a “speed reducer” can further operate stably.

In other embodiments, the number of drive cam grooves 400 and the number of driven cam grooves 500 may be any number as long as the number of drive cam grooves 400 and the number of driven cam grooves 500 are three or more. In addition, the number of balls 3 may be adjusted according to the number of drive cam grooves 400 and driven cam grooves 500.

The present disclosure can be applied not only to the vehicle that travels by a drive torque from the internal combustion engine, but also to an electric vehicle, a hybrid vehicle, or the like that can travel by a drive torque from a motor.

In other embodiments, the torque may be input from the “second transmission portion”, and output from the “first transmission portion” via the “clutch”. In addition, for example, when one of the “first transmission portion” and the “second transmission portion” is non-rotatably fixed, the rotation of the other of the “first transmission portion” and the “second transmission portion” can be stopped by making the “clutch” to the engaged state. In this case, the clutch device can be used as a brake device.

As described above, the present disclosure is not limited to the above embodiments, and can be implemented in various forms within a scope not departing from the concept of the present disclosure.

The control unit of the clutch device and the method thereof described in the present disclosure may be implemented by a dedicated computer that is provided by forming a processor and a memory programmed to execute one or more functions embodied by a computer program. Alternatively, the control unit of the clutch device and the method thereof described in the present disclosure may be implemented by a dedicated computer provided by configuring a processor with one or more dedicated hardware logic circuits. Alternatively, the control unit of the clutch device and the method thereof described in the present disclosure may be implemented by one or more dedicated computers formed by a combination of a processor and a memory programmed to execute one or multiple functions and a processor formed by one or more hardware logic circuits. In addition, the computer program may be stored in a computer-readable non-transitional tangible recording medium as an instruction executed by a computer.

The present disclosure has been described, based on the embodiments. However, the present disclosure is not limited to the embodiments and the structures. The present disclosure also includes various modification examples and modifications within the scope of equivalents. In addition, various combinations and forms, and further, other combinations and forms which include only one element, more elements, or fewer elements are included in the scope and the spirit of the present disclosure.

What is claimed is:

1. A clutch actuator to be used in a clutch device, the clutch device including a clutch provided between a first transmission portion and a second transmission portion that are rotatable relative to each other and whose state is changeable between an engaged state in which torque transmission between the first transmission portion and the second transmission portion is permitted and a non-engaged state in which the torque transmission between the first transmission portion and the second transmission portion is blocked, the clutch actuator comprising:
a housing;
a prime mover including a stator provided in the housing, a rotor configured to rotate relative to the stator, and a magnet provided in the rotor, the prime mover configured to operate by energization and output a torque from the rotor;
a magnet cover provided to cover at least a part of the magnet;
a speed reducer configured to output the torque of the prime mover at a reduced speed; and
a rotational translation unit including a rotation portion, which is configured to rotate relative to the housing when the torque output from the speed reducer is input, and a translation portion, which is configured to move relative to the housing in an axial direction when the rotation portion rotates relative to the housing and is configured to change the state of the clutch to the engaged state or the non-engaged state, wherein
the speed reducer includes
a sun gear configured to input the torque from the rotor,
a planetary gear configured to revolve in a circumferential direction of the sun gear while meshing with the sun gear and rotating on its axis,
a carrier rotatably supporting the planetary gear and rotatable relative to the sun gear,
a first ring gear configured to mesh with the planetary gear, and
a second ring gear configured to mesh with the planetary gear, having a number of teeth of a tooth portion different from that of the first ring gear, and configured to output the torque to the rotation portion,
the carrier is provided on a radially outer side of the sun gear and on a radially inner side of the first ring gear and the second ring gear, the carrier configured to come into contact with the magnet cover or the rotation portion, and
the magnet cover is made of a non-magnetic material.

2. The clutch actuator according to claim 1, wherein
the magnet cover includes a cover plate portion that covers the magnet on a side of the carrier.

3. The clutch actuator according to claim 1, wherein
the magnet cover has a cover protruding portion configured to come into contact with the carrier.

4. The clutch actuator according to claim 3, wherein
an outer wall of the cover protruding portion, which is configured to come into contact with the carrier, is formed such that a shape of the outer wall in a cross section along a plane including an axis of the magnet cover is a curved shape that protrudes toward the carrier.

5. The clutch actuator according to claim 1, wherein
the carrier includes a pin provided at a rotation center of the planetary gear such that an end portion of the pin is configured to come into contact with the magnet cover or the rotation portion.

6. The clutch actuator according to claim 5, wherein
an end portion of the pin is formed in an SR shape.

7. The clutch actuator according to claim 5, wherein
at least one of the magnet cover or the rotation portion has an annular pin sliding groove portion on which the end portion of the pin is slidable.
